(19) United States
(12) Patent Application Publication
(10) Pub. No.: US 2015/0269077 A1
(43) Pub. Date: Sep. 24, 2015

(54) METHOD FOR RUNNING CACHE INVALIDATION IN COMPUTER SYSTEM

(71) Applicant: Advanced Digital Chips Inc., Gyeonggi-do (KR)

(72) Inventors: KWANG HO LEE, Seoul (KR); YOUNG HO CHA, Gyeonggi-do (KR); SOO HYUN KUM, Gyeonggi-do (KR); CHANG SEON JO, Gyeonggi-do (KR); KWAN YOUNG KIM, Gyeonggi-do (KR)

(73) Assignee: Advanced Digital Chips Inc., Gyeonggi-do (KR)

(21) Appl. No.: 14/261,149

(22) Filed: Apr. 24, 2014

(30) Foreign Application Priority Data
Mar. 20, 2014 (KR) 10-2014-0032746

(51) Int. Cl. G06F 12/08

(52) U.S. Cl. CPC G06F 12/0833; G06F 2212/62

(57) ABSTRACT

Provided is a method for running cache invalidation in a computer system including: checking whether or not the cache invalidation is in a range mode when the cache invalidation is started; resetting an internal count associated with the invalidation if the cache invalidation is in the range mode; accessing a cache entry; checking whether or not a tag is ‘hit’ as a result of the accessing to the cache entry; checking whether or not a state of the cache is dirty if the tag is ‘hit’; performing write operation on the memory and clearing the cache entry if the state of the cache is dirty; clearing the cache entry if the state of the cache is not dirty; incrementing the internal count by 1 if the tag is not ‘hit’ or if the cache entry is cleared; and ending the cache invalidation if the internal count exceeds a predetermined offset.

### CROSS REFERENCES TO RELATED APPLICATIONS

This application claims priority to Korean Patent Application No. 10-2014-0032746, filed in the Korean Patent Office on Mar. 20, 2014, the entire contents of which are incorporated herein by reference.

### FIELD

The present invention relates to a method for running cache invalidation method in a computer.

### BACKGROUND

Computer systems including a block access device using cache memories have been widely used. Generally, in the computer systems, the cache memories are externally connected to a CPU (Central Processing Unit) or are built in the CPU.

At recent, microprocessors including cache memories are used. The cache memories are used to hold information so that a CPU can speedily obtain the information from a main storage device or an external storage device.

In general, in a case where data and instructions required by the CPU is not held in the cache memory, that is, a ‘miss’ time, the CPU allows the required data to input from the storage device to the cache memory. At this time, data in a predetermined size of a memory area are transmitted in order from the storage device to the cache memory. In other words, the data are transmitted in units of a block. This operation is called a cache-in operation. Generally, data together with the correlated consecutive addresses are stored in the storage device. Therefore, one data block is transmitted to the cache memory in one bus cycle according to an address supplied to the storage device by the CPU. This is called a block access. Generally, since one block is configured to include a plurality of words, in a block access period, these words are consecutively transmitted in one bus cycle according to the address supplied by the CPU.

When an address which the CPU is to access is held in the cache, it is represented that the cache is in a ‘hit’ state. When an address which the CPU is to access is not held in the cache and thus the CPU directly accesses a memory to obtain the address, it is represented that the cache is in a ‘miss’ state.

Like this, if information required by the CPU is not held in the cache, the information is transmitted from the memory to the cache.

Cache operations include read operation and write operation.

In read operation, in the case where the cache is in a ‘hit’ state, that is, the state where the information required by the CPU is held in the cache, the information held in the cache is transmitted to the CPU.

In read operation, in the case where the cache is in a ‘miss’ state, that is, the state where the information required by the CPU is not held in the cache, the required information is fetched from the memory to the cache, and the information fetched to the cache is transmitted to the CPU.

In write operation, in the case where the cache is in a ‘hit’ state, that is, the state where the information which is to be changed by the CPU is held in the cache, the CPU changes the information held in the cache.

In write operation, in the case where the cache is in a ‘miss’ state, that is, the state where the information which is to be changed by the CPU is not held in the cache, the to-be-changed information is fetched from the memory to the cache, and the information of the cache is changed with the information fetched to the cache.

When a cache is updated with data but a memory is not updated with the data, it is represented that the cache is in a ‘dirty’ state.

FIGS. 1A and 1B are conceptual diagrams illustrating structures of connection of CPUs, caches, and memories.

In FIG. 1A, information of num=10 is stored in a memory 30.

In FIG. 1B, when CPU#2 20 requests num to be changed into 20, the num of a second cache 22 and the num of the memory 30 are changed into 20. At this time, a first cache 12 of CPU#1 10 is in a state where information of num=10 is held in the first cache 12. Accordingly, a problem occurs in that the num information of the CPU#1 10 is not coincident with the num information stored in the memory 30.

In order to solve the problem, a cache snooping method and a cache invalidation method are used.

In the cache snooping method, each cache is allowed to be continuously coincident by using a logic of monitoring change in the caches of two CPUs.

In the cache invalidation method, a memory is forcibly updated with content of a cache by using instructions.

In the cache invalidation scheme, in the case where there is no change in the content of the cache, the cache is flushed.

In other words, the cache invalidation denotes applying a change in the content of the cache to the memory or flushing the content of the cache.

In the related art, the cache invalidation is performed in a way base invalidation scheme or in an address base invalidation scheme. However, there are problems in that too much invalidation time is taken or repetitive software control is needed.

Korean Patent Application Laid-Open No. 10-1991-0017286 is mentioned in the background of this application.

### SUMMARY

The present invention is to provide a method for running cache invalidation capable of effectively and speedily running cache invalidation.

The present invention is not limited to the aforementioned object, but other objects that are not mentioned are to be understood by the ordinarily skilled in the related art.

According to an aspect of the present invention, there is provided a method for running cache invalidation in a computer system having a CPU, a memory, and a cache, including: checking whether or not the cache invalidation is in a range mode when the cache invalidation is started; resetting an internal count associated with the invalidation if the cache invalidation is in the range mode; accessing a cache entry; checking whether or not a tag is ‘hit’ as a result of the accessing to the cache entry; checking whether or not a state of the cache is dirty if the tag is ‘hit’; performing write operation on the memory and clearing the cache entry if the state of the cache is dirty; clearing the cache entry if the state of the cache is not dirty; incrementing the internal count by 1 if the tag is not ‘hit’ or if the cache entry is cleared; and ending the cache invalidation if the internal count exceeds a predetermined offset.

In the above aspect, until the internal count exceeds the offset, accessing entries of the entire cache ways, checking whether or not the tag is ‘hit’, checking whether or not the state of the cache is dirty, performing write operation on the memory, clearing the cache entry, and incrementing the internal count by 1 may be repeated.

In addition, the above aspect, when an index is an address required for accessing an entry of a cache way, a combination of the internal count and an address value in the range mode may be used as the index in order to access the entries of the entire cache ways.

In addition, the above aspect, if the cache invalidation is not in the range mode, the cache invalidation may be performed in a way-base invalidation scheme or an address-base invalidation scheme.

According to the present invention, it is possible to effectively and speedily run cache invalidation by performing range-based cache invalidation.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B are conceptual diagrams illustrating connections of CPUs, caches, and memories;

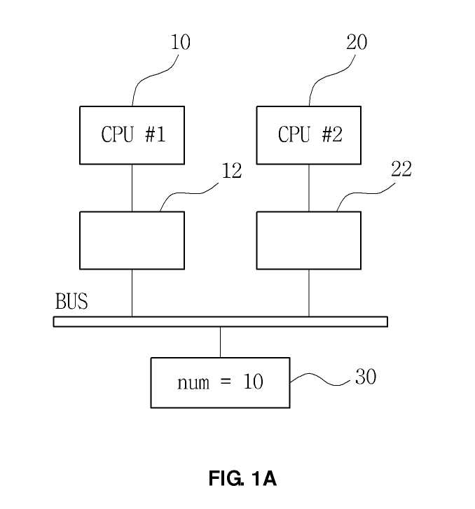

FIG. 2 is a diagram for explaining a way-base invalidation scheme in the related art;

FIG. 3 is a diagram for explaining an address-base invalidation scheme in the related art;

FIG. 4 is a flowchart illustrating a cache invalidation method according to an embodiment of the present invention;

FIG. 5 is a conceptual diagram illustrating a configuration of a cache invalidation register according to the embodiment of the present invention; and

FIG. 6 is a diagram for explaining a range-base invalidation operation according to the embodiment of the present invention.

### DETAILED DESCRIPTION

Since various modifications are available and various embodiments are exemplified, the present invention will be described in detail by particular embodiments with reference to the drawings. However, it should be noted that the present invention is not limited to the embodiments, but it includes all the modifications, equivalents, and substitutes.

Terms used in the specification are intended to explain particular embodiments but not intended to limit the present invention. If not expressed in a definite manner, an element expressed with a singular term is intended to include a plurality of the elements. In the specification, terms “to comprise”, “to include”, and “to have” and the like should be understood that they are intended to represent the existence of features, numbers, steps, operations, components, parts, or a combination thereof but not intended to exclude the existence of or a possibility of addition of features, numbers, steps, operations, components, parts, or a combination thereof in advance. If not defined as different meanings, all the terms including technical or scientific terms have the same meanings as they are generally understood by the ordinarily skilled in the related art. The terms defined in generally-used dictionaries should be understood to have the same meanings as they have in context of related technologies. If not explicitly defined in the specification, the terms should not be understood in view of ideal meanings or strictly literal meanings.

In addition, in the description of the drawings, the same components are denoted by the same reference numerals, and the redundant description thereof will be omitted. If the present invention may be unclear by describing a well-known technique, the detailed description thereof will be omitted.

The present invention relates to cache invalidation in a computer system which is configured to include a CPU (central processing unit), memories, and caches. In an embodiment of the present invention, the memory is preferably a RAM (Random Access Memory).

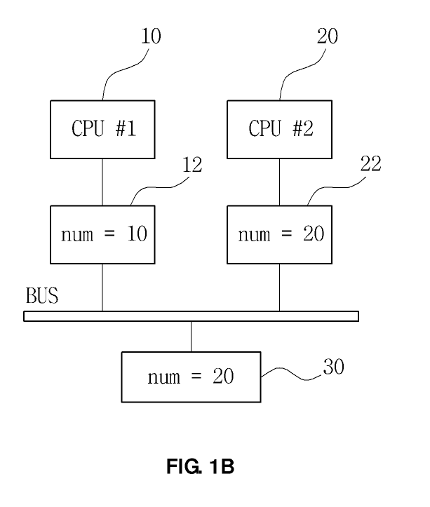

FIG. 2 is a diagram for explaining a way-base invalidation scheme.

Referring to FIG. 2, in the way-base invalidation scheme, caches are reset in units of a way. In addition, the entire ways are reset without consideration of physical addresses.

The way-base invalidation scheme is mainly used for resetting the entire caches. Since all the data of the ways are reset, there is a disadvantage in that too much time is taken. (2) To reduce the number of registered used for an operation,

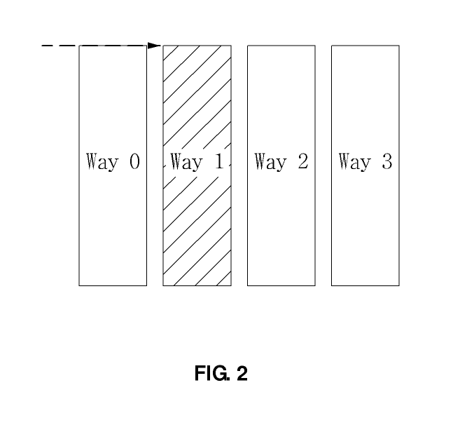

FIG. 3 is a diagram for explaining an address-base invalidation scheme.

Referring to FIG. 3, in the address-base invalidation scheme, caches are reset in units of an address. In addition, the address-base invalidation scheme is used for immediately matching data of a specific physical address.

In the address-base invalidation scheme, cache invalidation is performed on only the lines including a specific address. However, the address-base invalidation scheme has a disadvantage in that repetitive software control is needed in order to perform the cache invalidation in such a predetermined range.

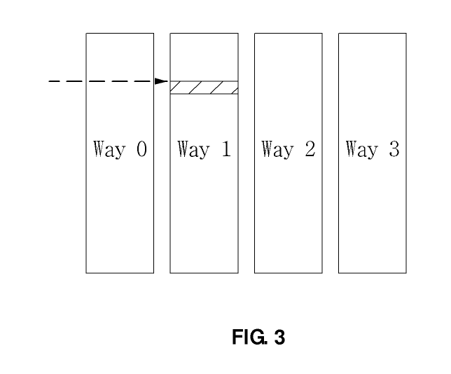

FIG. 4 is a flowchart illustrating a cache invalidation method according to an embodiment of the present invention.

Referring to FIG. 4, the cache invalidation method according to the embodiment of the present invention is as follows.

Firstly, when the cache invalidation is started (S401), it is checked whether or not the cache invalidation is in a range mode (S403).

If the cache invalidation is not in the range mode, the cache invalidation is performed in a cache invalidation scheme of the related art (S421). The cache invalidation scheme of the related art may be a way-base invalidation or an address-base invalidation.

If the cache invalidation is in the range mode, an internal count associated with the invalidation is reset (S405).

Next, accessing a cache entry is performed (S409).

Next, it is checked whether or not a tag is ‘hit’ (S411).

If the tag is ‘hit’, it is checked whether or not a state of the cache is dirty (S413).

If the state of the cache is dirty, the CPU executes write operation on the memory (S415), and the cache entry is cleared (S417).

If the state of the cache is not dirty, the cache entry is cleared (S417).

Next, the internal count is incremented by 1 (S419).

Until the internal count exceeds a predetermined offset, Steps S407 to S419 are repeated. When the internal count exceeds the offset, the cache invalidation is ended.

In the embodiment of the present invention, when an index is an address required for accessing an entry of a cache way, a combination of the internal count and an address value in the range mode may be used as the index in order to access the entries of the entire cache ways.

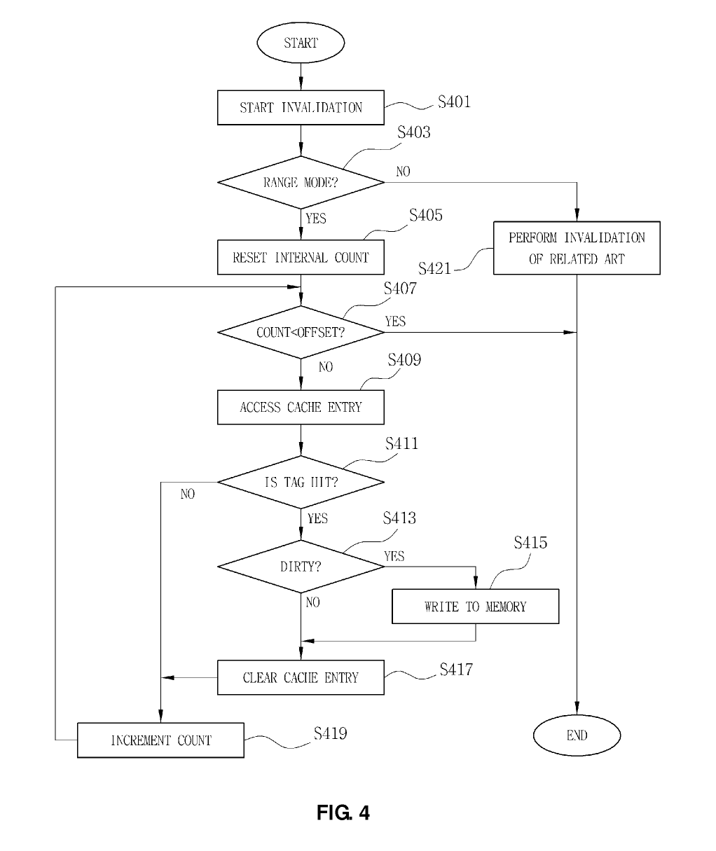

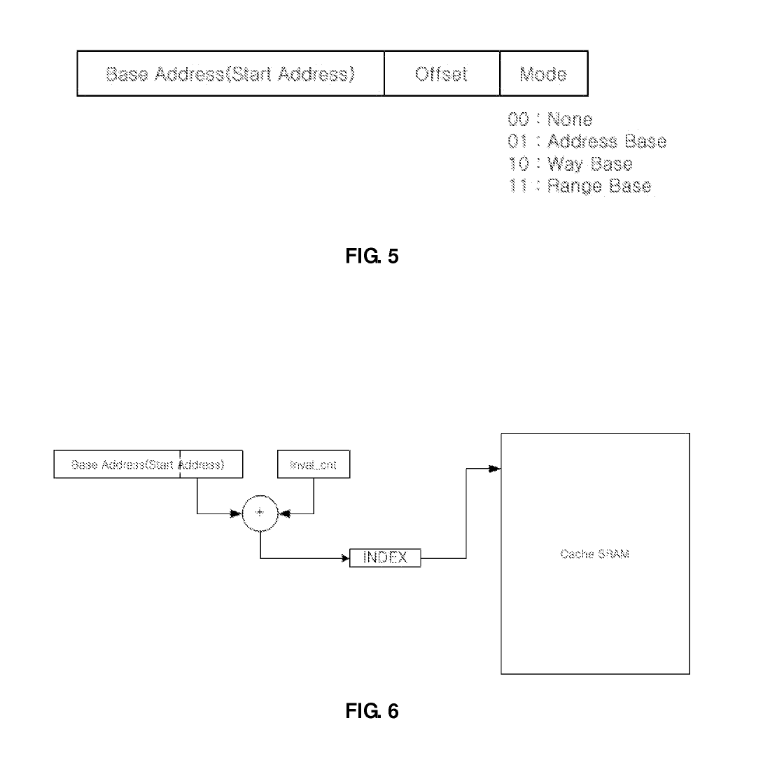

FIG. 5 is a conceptual diagram illustrating a configuration of a cache invalidation register according to the embodiment of the present invention, and FIG. 6 is a diagram for explaining a range-base invalidation operation according to the embodiment of the present invention.

Referring to FIGS. 5 and 6, the cache invalidation register according to the present invention is configured to include a base address, an offset, and a mode.

For example, with respect to the mode of the cache invalidation register, 01 denotes an address base mode, 10 denotes a way base mode, and 11 denotes a range base mode.

The range-base invalidation operation is performed from the base address of the cache invalidation register up to an offset.

An index is generated by addition of the base address and the count (Inval_cnt), and a cache SRAM can be accessed according to the generated index.

The count (Inval_cnt) is incremented by 1. If the count exceeds the offset, cache invalidation is ended.

While the present invention has been particularly shown and described with reference to exemplary embodiments thereof, it will be understood by those skilled in the art that the present invention is not limited to the exemplary embodiments and various changes in form and details may be made therein without departing from the spirit and scope of the invention as defined by the appended claims.

What is claimed is:

1. A method for running cache invalidation in a computer system having a CPU, a memory, and a cache, comprising:
checking whether or not the cache invalidation is in a range mode when the cache invalidation is started;
resetting an internal count associated with the invalidation if the cache invalidation is in the range mode;
accessing a cache entry;
checking whether or not a tag is ‘hit’ as a result of the accessing to the cache entry;
checking whether or not a state of the cache is dirty if the tag is ‘hit’;
performing write operation on the memory and clearing the cache entry if the state of the cache is dirty;
clearing the cache entry if the state of the cache is not dirty;
incrementing the internal count by 1 if the tag is not ‘hit’ or if the cache entry is cleared; and
ending the cache invalidation if the internal count exceeds a predetermined offset.

2. The method according to claim 1, wherein until the internal count exceeds the offset, accessing entries of the entire cache ways, checking whether or not the tag is ‘hit’, checking whether or not the state of the cache is dirty, performing write operation on the memory, clearing the cache entry, and incrementing the internal count by 1 are repeated.

3. The method according to claim 2, wherein, when an index is an address required for accessing an entry of a cache way, a combination of the internal count and an address value in the range mode is used as the index in order to access the entries of the entire cache ways.

4. The method according to claim 2, wherein if the cache invalidation is not in the range mode, the cache invalidation is performed in a way-base invalidation scheme.

5. The method according to claim 2, wherein if the cache invalidation is not in the range mode, the cache invalidation is performed in an address-base invalidation scheme.
